(19) United States
(12) Patent Application Publication
(10) Pub. No.: US 2005/0233659 A1
(43) Pub. Date: Oct. 20, 2005

(54) Composition for construction with reinforcing and heat transferring layer

(76) Inventor: Guerry E. Green, Pawleys Island, SC (US)

Correspondence Address: MICHAEL A. MANN;NEXSEN PRUET, LLC, POST OFFICE DRAWER 2426, COLUMBIA, SC, 29202-2426, US

(21) Appl. No.: 11/105,955

(22) Filed: Apr. 14, 2005

Related U.S. Application Data
(60) Provisional application No. 60/563,361, filed on Apr. 19, 2004.

(51) Int. Cl. B32B 5/18

(52) U.S. Cl. 442/59; 442/6; 442/9; 442/52; 442/55; 442/117

(57) ABSTRACT

A construction material and method for making same, made preferably of polymeric material, into which has been incorporated upon extrusion a metal web that has a relatively higher thermal conductivity coefficent and relatively greater tensile strength than the extruded polymeric material. The web is incorporated below but near the surface of the member and preferably connecting at least the side that will be exposed to heat and a side opposite that side so that heat is transfered from the exposed side to side that is not exposed to equalize the thermal loading and thereby reduce bowing. Further, the web, having good tensile strength, resists that bowing that might otherwise still occur and generally makes the material stronger.

### CROSS REFERENCE TO RELATED APPLICATIONS

The priority benefit of U.S. provisional application Ser. No. 60/563,361 filed Apr. 19, 2004 is claimed.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates generally to construction materials for use in homes and office buildings and more particularly to polymeric construction materials that take the place of wood or metal.

The use of polymeric materials as substitutes for wood or metal in construction has increased. Shutters, molding and screen doors made of vinyl are known and have various advantages over wood-based products. They require less maintenance, for example. However, they also have drawbacks. If the construction member is exposed to direct sunlight, and is a dark color, it will tend to bow as it expands from the heat of the sun, and then contract when the sun goes down. The bowing may become permanent, resulting in a distortion and loosening of the member from its proper location. The distortion may be sufficiently great that it prevents the member from being properly reattached. Bowing is not a significant problem in light colored or white construction members.

It is also known to add fillers and strengtheners to polymers. These fillers and strengtheners include wood flour and chopped fiberglass to name two examples. These can decrease cost or improve properties of the polymers.

However, there remains a need for a way to decrease the impact of non-uniform exposure to heat on polymeric compositions used in construction so that they bow less and distort less from this exposure.

### SUMMARY OF THE INVENTION

Briefly recited and in accordance with its preferred embodiments, the present invention is a polymeric composition for use as a construction material that is stiffer and more resistant to bowing. It is also a method for making the construction material.

In its preferred embodiment, the construction material is a polymer, preferably foamed plastic such as foamed vinyl, ABS, ASA and others, into which has been incorporated a mesh metallic web material that has a relatively greater thermal conductivity coefficient and relatively greater tensile and compressive strength than the polymeric, extrudable material into which it is incorporated. The web material is incorporated below but near the surface of the polymeric material and preferably on at least the side that will be exposed to heat and a side opposite that side so that heat is transferred away from the exposed side and to the opposing side in order to equalize the thermal loading, reduce the thermal gradient and thereby reduce bowing and distortion. Further, the web, having good tensile and compressive strength, helps to resist the bowing that might nonetheless still occur and generally makes the material stronger.

In addition to the web, conductive filler can be added to the surface of the composition, which is the “cap” layer, preferably to the depth of the mesh. This conductive filler can be for example, metal particles or fibers, such as aluminum or steel particles or fibers. These fibers can assist in transferring heat to the mesh. whence it is further transferred to the opposing side of the composition material.

A feature of the present invention is the use of a web material just below the surface. In this location, the mesh can transfer heat to another portion of the material before it penetrates too far into the material and begins to cause bowing. It can also provide resistance to the bowing at the point it is going to occur.

Another feature of the present invention is the choice of a web material that both readily transfers heat and strongly resists bowing. This material, such as aluminum or steel mesh, adds significantly to the structural strength of the polymeric member at reasonable cost without introducing manufacturing complexity.

Still another feature is the use of web to move heat absorbed by one part of a construction member quickly from a heat absorbing side to a particular part of the member. The specific design of the web layout can thus allow not only the removal of heat from the exposed area and transfer to another area but can also deliver the removed heat to a location in the member where that heat can be radiated out of the member and/or counteract the effects of the heat deposited in the heat absorbing side. Thus, the location of the web can be engineered to provide superior heat redistribution performance.

Yet another feature of the present invention is the use of heat conducting fillers in the cap layer in combination with the web. The fillers can move heat more quickly to the web.

Other features and their advantages will become readily apparent to those skilled in the art of construction materials from a careful reading of the Detailed Description of Preferred Embodiments, accompanied by the drawings.

### BRIEF DESCRIPTION OF THE DRAWINGS

In the drawings,

FIG. 1 is a perspective view of a construction member showing its profile and the location of the web, according to a preferred embodiment of the present invention;

FIG. 2 is a schematic diagram of the manufacturing of the member shown in FIG. 1, according to a preferred embodiment of the present invention.

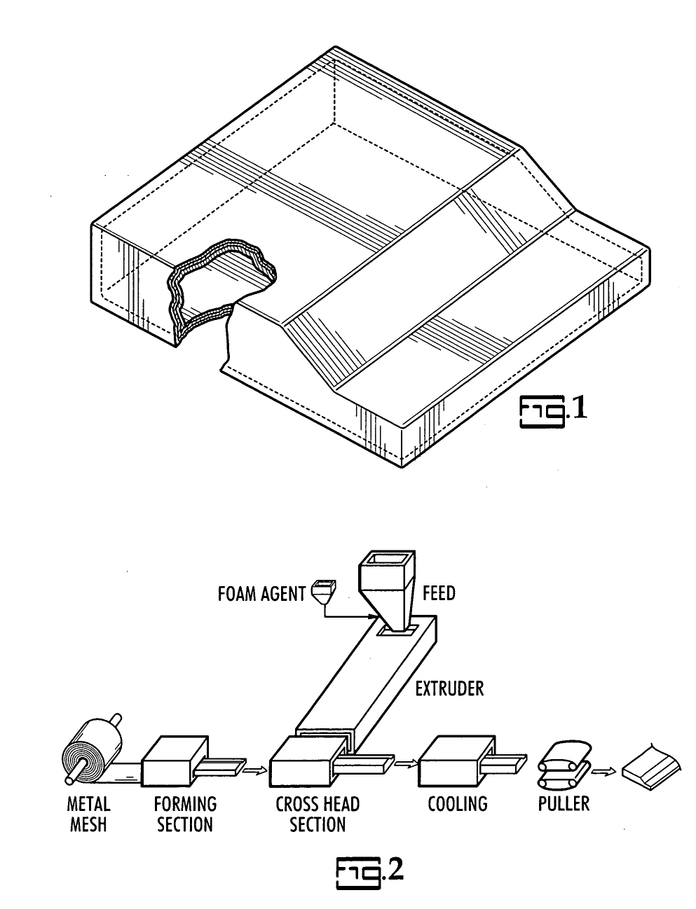

### DETAILED DESCRIPTION OF PREFERRED EMBODIMENTS

The present invention is a composition for construction materials, construction materials made using the composition, and a method for making construction materials. Construction material means an article of manufacture having pre-designated dimensions and properties that is intended to become part of a residence, office or other building.

The present composition has two elements. The first is an extruded material and the second is a web that is incorporated into the extruded material. The extruded material is preferably a polymeric material such as vinyl, and most preferably a foamed polymeric material. However, a number of polymeric materials other than vinyl may be used such as ABS and ASA. The characteristics of the extruded material, other than being manufactured by extrusion or vacuum molding are that it be durable when exposed to the natural elements (heat, cold, rain, snow, wind, dust) rather than material that degrades too quickly over time to serve any useful purpose in construction, that it have suitable tensile and compressive strength under load so that it can be used to bear the intended load when used in residential and some commercial construction, and that it can be made in a size that generally fits the dimensional requirements of the task for which it is to be used.

The second element is a web that is incorporated into the extruded material in such a way that it is not visible from the outside of the construction member but is just below the surface and extends around a significant portion of the perimeter of the construction member so that it can redistribute heat from one portion of the member to another portion. Web means a latticework membrane that has holes sufficiently large enough to allow the extruded material to flow through the holes during extrusion. The holes can be the result of perforations formed in an otherwise continuous sheet of material or gaps between filaments. The web has two functions: namely, providing additional strength and conducting heat. Therefore, the web is preferably made of a material with greater tensile strength and a higher thermal conductivity coefficient than the extruded material, such as a metal or metal alloy, preferably aluminum or steel.

The extrudable material is fed into an extruder along with a foaming agent if desired, in a manner well known in the prior art, while web is unwound from a spool and pulled through a forming section. Alternatively, the web may be supplied as a formed web from a metal extrusion system and perforation system. The formed or extruded web is then introduced into a cross head receiving the extruded material to fill the spaces around the formed web with extruded material and thereby extrude the material with the web embedded in it. The extruded member may then be processed to give it a suitable surface treatment so that it resists scratching and has whatever desired appearance the users wishes.

Preferably the mesh-like web is placed under tension prior to becoming embedded in the extruded material until the polymer sets. The behavior of the web is subsequently dependent primarily on the physical properties of the material of which it is made, which in turn heavily influences the properties of the resulting composition.

The construction member so formed may be used in a number of different applications but primarily as a replacement for wood products used in construction, and especially in construction of exterior trim and siding where sunlight exposure is expected. For example, the present material may be used in making hinged and sliding door rails and styles, shutters, siding, molding, soffit and fascia boards, porch railings and decking, and skirt boards.

In the design of these construction members, there will be a heated side, typically a side that is expected to face the sun, and an opposing side. Normally, polymers will expand when heated and contract when they cool, and will not maintain their geometry with repeated cycles of expansion and contraction. However, when the web is incorporated, the construction member will have additional stiffness to resist expansion and contraction. In addition, the property of lower thermal expansion and contraction associated with the web material will limit that property of the polymer to which it is bound. Furthermore, the heat-conducting capability of the web carries heat from the heated side to another part of the construction member to redistribute the heat, and preferably distribute it more evenly to minimize heat gradients. In particular if the web is positioned just below the surface of the heated side and runs to the opposing side, then heat can be distributed to the opposing side and reduce the thermal gradient across the construction member and make it somewhat less asymmetric, which further minimizes the distortion wrought by the heat of the sun and counter acts the tendency to bow.

Structural analysis, which is a well-known type of analysis using physical principles and mathematics, can determine effective ways to position the web within the extruded material of a construction member and, upon the simulation of the occurrence of heat applied to the heated side of the member, the effect of that the web in redistributing the heat load on the construction member can be ascertained. Changes in the positioning of the web will change the effect, and the location of the web having the more desirable effect can be selected.

Of course, the heated side should have the web positioned below the surface so that it will not be visible from the exterior but near the surface so that it carries the heat it picks up and carries it by a short route (and potentially plural routes). The amount of web and its location can be balanced so that it provides similar stiffening of the construction member against bowing from heat as well as against contraction by having web on both the heated side and the side opposite the heated side.

It is expected that the web will serve a strengthening function in addition to a heat redistribution function. When the construction member is extruded, the polymer will penetrate into the openings in the web to form a tight structure are not independent of each other. Furthermore, the arrangement of the web can not only move heat from the exposed side to the opposing side but can also add strength in accordance with the anticipated load. For example, the web can be arranged to form I-beams and box beams or corrugated sheets in the polymeric matrix. The precise arrangement will depend on a modest amount of engineering once the application and loads on the construction member are known.

In an alternative embodiment, the plastic composition may include filler particles at least in the cap layer that facilitates transfer of heat to the web. These particles are made of a material that transfers heat better than the plastic of which the composition is primarily made but do not otherwise degrade is performance or appearance. The particles may be made of a metal or metal alloy such as aluminum, aluminum alloy or steel and are incorporated in the cap or surface layer of the plastic to the depth of the metal web.

Those skilled in the art of construction materials will appreciate that many modifications and substitutions may be made to the foregoing preferred embodiments without departing from the spirit and scope of the present invention, defined by the appended claims.

1. A composition for use in residential construction, said composition comprising:
a polymeric material having a first side and a second side and a surface, said polymeric material having a thermal conductivity coefficient; and
a web embedded in said polymeric material and extending from said first side to said second side, said web having a thermal conductivity coefficient greater than said thermal conductivity coefficient of said polymeric material so that, when said first side of said polymeric material absorbs heat, said web conducts said heat to said second side of said polymeric material.

2. The composition as recited in claim 1, wherein said web is made of metal.

3. The composition as recited in claim 1, wherein said web is made of metal latticework.

4. The composition as recited in claim 1, wherein said polymeric material includes foamed plastic.

5. The composition as recited in claim 1, wherein said polymeric material includes polyvinyl chloride.

6. The composition as recited in claim 1, wherein said polymeric material is foamed polyvinyl chloride.

7. The composition as recited in claim 1, further comprising thermally conductive filler dispersed in said polymeric material between said web and said first side.

8. The composition as recited in claim 1, wherein said thermally conductive filler includes metal particles.

9. The composition as recited in claim 1, wherein said web is in the form of an I-beam having a top of said I-beam just below said surface of said first side and a bottom of said I-beam just below said surface of said second side.

10. The composition as recited in claim 1, wherein said web is in the form of a box beam having a top of said box beam just below said surface of said first side and a bottom of said box beam just below said surface of said second side.

11. A composition for use in residential construction, said composition comprising:
a foamed plastic material having a first side and a second side and a surface; and
a metal web embedded in said foamed plastic material just below said surface and extending from said first side to said second side so that, when said first side of said foamed plastic material absorbs heat, said web conducts said heat from said first side to said second side of said foamed plastic material.

12. The composition as recited in claim 11, further comprising metal particles dispersed in said foamed plastic material between said web and said surface.

13. The composition as recited in claim 11, wherein said metal web is made of aluminum.

14. The composition as recited in claim 11, wherein said foamed plastic includes foamed polyvinyl chloride.

15. The composition as recited in claim 11, wherein said web is in the form of an I-beam having a top of said I-beam just below said surface of said first side and a bottom of said I-beam just below said surface of said second side.

16. The composition as recited in claim 11, wherein said web is in the form of a box beam having a top of said box beam just below said surface of said first side and a bottom of said box beam just below said surface of said second side.

17. A method for making a construction material, said method comprising the steps of:
forming a metal mesh; and
extruding a polymeric material having a surface with said metal mesh near said surface.

18. The method as recited in claim 17, further comprising the step of placing said metal mesh under tension during said extruding step.

19. The method as recited in claim 17, further comprising the step of applying a polymeric cap over said metal mesh.

20. The method as recited in claim 17, further comprising the steps of:
mixing metal particles with a polymer to form a mixture; and
applying said mixture as a cap over said metal mesh and said extruded polymeric material.
